(19) United States
(12) Patent Application Publication
(10) Pub. No.: US 2018/0130571 A1
(43) Pub. Date: May 10, 2018

(54) ALUMINUM TWISTED WIRE AND WIRE HARNESS

(71) Applicant: YAZAKI CORPORATION, Tokyo (JP)

(72) Inventor: Hiroyuki MASUI, Susono-shi (JP)

(73) Assignee: YAZAKI CORPORATION, Tokyo (JP)

(21) Appl. No.: 15/803,112

(22) Filed: Nov. 3, 2017

(30) Foreign Application Priority Data
Nov. 9, 2016 (JP) 2016-218542

(51) Int. Cl. H01B 5/08; H01B 1/02; H01B 7/00

(52) U.S. Cl. CPC H01B 5/08; H01B 7/0045; H01B 1/023

(57) ABSTRACT

An aluminum twisted wire includes a plurality of aluminum wires that are twisted together. Each of the aluminum wires includes a conductor having a plurality of wire elements that are twisted together, and an insulator covering the conductor. The wire elements forming the conductor are made of aluminum or aluminum alloy. A twisting direction of the wire elements and a twisting direction of the aluminum wires are the same. A wire harness includes this aluminum twisted wire.

### CROSS-REFERENCE TO RELATED APPLICATION

The present application claims priority from Japanese Patent Application No. 2016-218542 filed on Nov. 9, 2016, the entire content of which is incorporated herein by reference.

### FIELD OF INVENTION

The present invention relates to an aluminum twisted wire and a wire harness.

### RELATED ART

Related art twisted wires are formed by twisting a plurality of electric wires, each electric wire having a conductor formed by twisting a plurality of metal wire elements and an insulator covering the conductor (see, e.g., JPS58-16087Y2, JP2011-258330A, JP2016-122656A and JPH10-125145A). To improve flex resistance, the twisted wires are configured such that the twisting direction of the metal wire elements forming the conductor and the twisting direction of the electric wires forming the twisted wire are opposite to each other.

Aluminum wires generally have lower strength and less flexibility as compared with copper wires. Accordingly, also with aluminum twisted wires having a plurality of aluminum wires, one can consider making the twisting direction of aluminum wire elements forming the conductor of each aluminum wire and the twisting direction of the aluminum wires opposite to each other. However, flex resistance of aluminum twisted wires formed in this manner is not so sufficient.

### SUMMARY

Illustrative aspects of the present invention provide an aluminum twisted wire and a wire harness having improved flex resistance.

According to an illustrative aspect of the invention, an aluminum twisted wire includes a plurality of aluminum wires that are twisted together. Each of the aluminum wires includes a conductor having a plurality of wire elements that are twisted together, and an insulator covering the conductor. The wire elements forming the conductor are made of aluminum or aluminum alloy. A twisting direction of the wire elements and a twisting direction of the aluminum wires are the same. A wire harness includes this aluminum twisted wire.

### BRIEF DESCRIPTION OF THE DRAWINGS

FIG. 1 is a perspective view of an example of a wire harness according to an exemplary embodiment of the present invention;

FIG. 2 is a perspective view of a portion of an aluminum twisted wire shown in FIG. 1;

FIG. 3 is a front view of an end portion of an aluminum twisted wire where the twisting directions are opposite to each other;

FIG. 4 is a front view of an end portion of the aluminum twisted wire according to an exemplary embodiment of the present invention;

FIG. 5 is a table showing an example of the present invention and comparative examples; and

FIG. 6 is a diagram illustrating a bending test.

### DETAILED DESCRIPTION

Hereinafter, exemplary embodiments of the present invention will be described in detail with reference to the drawings.

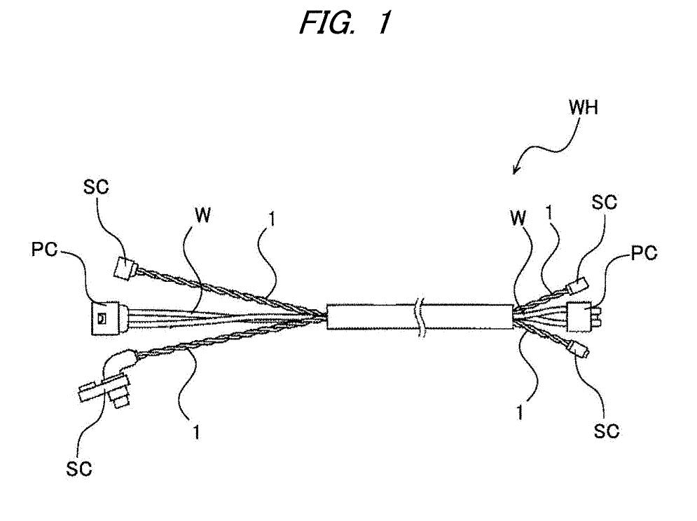

FIG. 1 is a perspective view of an example of a wire harness according to an exemplary embodiment of the present invention. As shown in FIG. 1, a wire harness WH has, for example, two power supply wires W and two aluminum twisted wires L, and these are accommodated in a sheath S. In the example shown in FIG. 1, the two aluminum twisted wires 1 are used as signal lines.

The two power supply wires W and the two aluminum twisted wires 1 are each exposed to the outside of the sheath S at both ends. Power supply connectors PC are attached at both ends of the two power supply wires W, respectively. Signal connectors SC are connected at both ends of the two aluminum twisted wires 1, respectively.

The wire harness WH is not limited to the example shown in FIG. 1 in so far as it has at least one aluminum twisted wire 1.

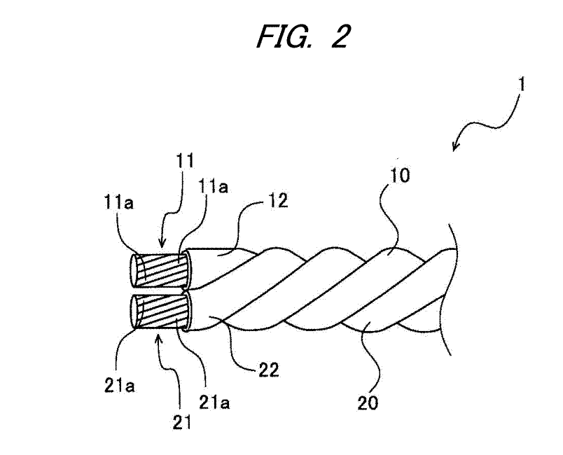

FIG. 2 is a perspective view of the aluminum twisted wire 1 shown in FIG. 1. As shown in FIG. 2, the aluminum twisted wire 1 has, for example, two aluminum wires 10, 20. The aluminum wires 10, 20 are twisted together to form the aluminum twisted wire 1. Each aluminum wire 10, 20 has a conductor 11, 21 and an insulator 12, 22 covering the conductor 11, 21.

Each conductor 11, 21 has a plurality of wire elements 11a, 21a. The wire elements 11a, 21a are twisted together to form the conductor 11, 21. The wire elements 11a, 21a are made of aluminum or an aluminum alloy. The elongation of each wire element 11a, 21a is preferably equal to or greater than 8%. The strength of each wire element 11a, 21a is equal to or greater than 110 MPa.

The twisting direction of the wire elements 11a, 21a and the twisting direction of the aluminum wires 10, 20 are the same. In the example shown in FIG. 2, the wire elements 11a, 21a and the aluminum wires 10, 20 are both S-twisted.

The inventor has found that if the twisting direction of the electric wires and the twisting direction of the wire elements are opposite to each other, a force is applied in a direction in which the twisted wires of the conductors are untwisted and this leads to reduction in flexibility.

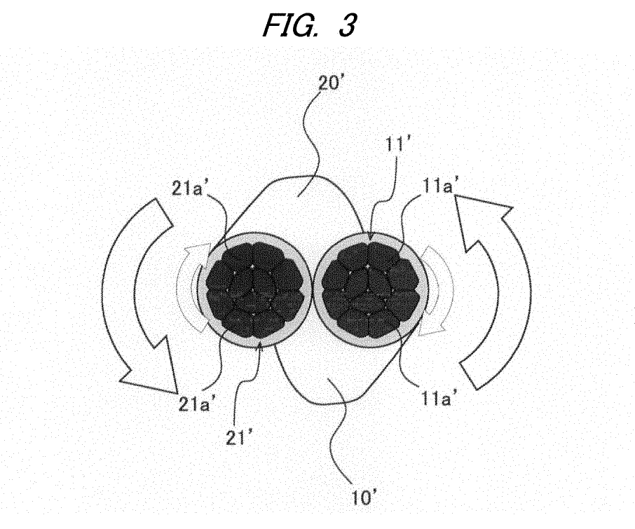

FIG. 3 is a front view of an end portion of an aluminum twisted wire where the twisting directions (directions of lay) are opposite to each other. Aluminum wires 10′, 20′ generally have lower strength and less flexibility as compared with copper wires. To improve flexibility of the aluminum wires 10′, 20′, the twist pitch (length of lay) of wire elements 11a′, 21a′ of conductors 11′, 21′ is shortened so as to reduce the distortion applied to each conductor 11′, 21′ at the time of bending. Thus, when the twisting direction of the electric wires 10′, 20′ are opposite to the twisting direction of the wire elements 11a′, 21a′ as shown in FIG. 3, a force is applied in a direction in which the wire elements 11a′, 21a′ are untwisted and this leads to reduction in flexibility.

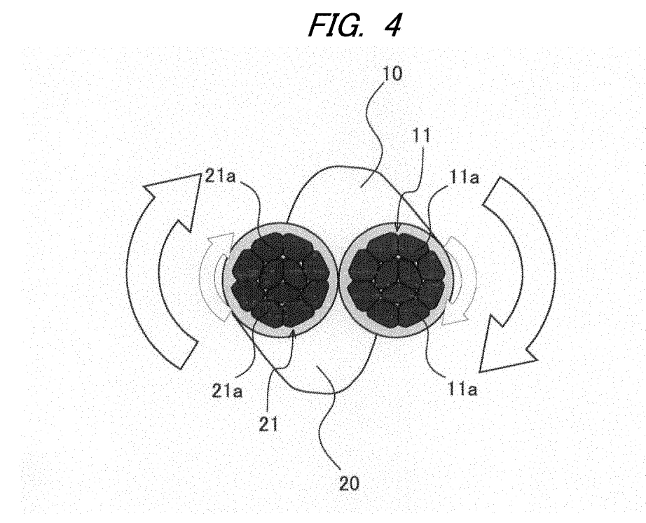

FIG. 4 is a front view of an end portion of the aluminum twisted wire 1 according to an exemplary embodiment of the present invention. This aluminum twisted wire 1 is configured such that the twisting direction of the wire elements 11a, 21a and the twisting direction of the aluminum wires 10, 20 are the same. Therefore, as shown in FIG. 4, force is applied to strengthen the twist of the conductors 11, 21, so that the wire elements 11a, 21a are less likely to be untwisted and flexibility can be improved.

The inventor has also found that making the twisting direction of the wire elements and the twisting direction of the electric wires the same does not contribute much in improving flexibility with copper wires, but with aluminum wires, improvement in flexibility at a level that cannot be achieved with the copper wires can be expected. More specifically, the inventor has found that, in a bending test, the number of times of bending is increased only by about ten percent in the case of copper wires, whereas in the case of aluminum wires, the number of times of bending is more than doubled (more preferably, more than tripled).

That is, by making the same the twisting direction of the wire elements 11a, 21a and the twisting direction of the aluminum wires 10, 20 in the aluminum twisted wire 1, flexibility can be improved more effectively than in copper twisted wires.

The twist pitch of the wire elements 11a, 21a forming the conductors 11, 21 is, for example, in a range of one third of the twist pitch of the two aluminum wires 10, 20 to three times the twist pitch of the two aluminum wires 10, 20.

With this configuration, the twist pitch of the wire elements 11a, 21a and the twist pitch of the two aluminum wires 10, 20 are limited to be in substantially in the same range. This can prevent can prevent the wire elements 11a, 12a or the aluminum wires 10, 20 from being untwisted. That is, when there is a large difference in the tightness of twist between the wire elements 11a, 21a and the aluminum wires 10, 20, e.g., when one of the twist pitches is long and the other is short, the ones that are twisted more tightly become easy to be untwisted.

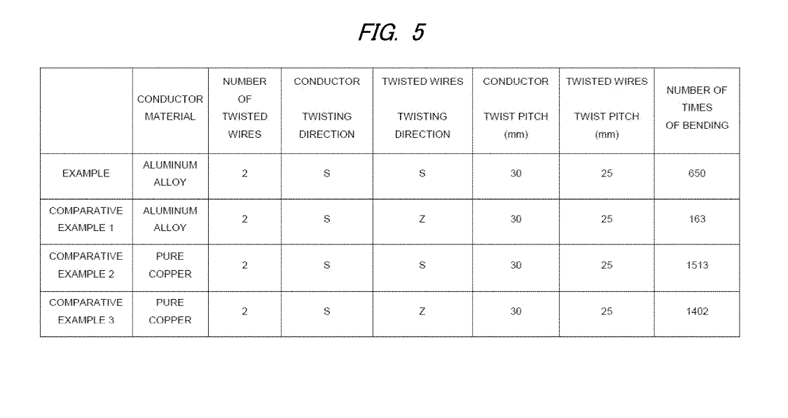

Next, twisted wires according to an example of the present invention and comparative examples will be described. FIG. 5 is a view showing the exemplary embodiment and the comparative examples.

As shown in FIG. 5, in the example of the present invention, the conductor was formed by S-twisting eleven wire elements with a twist pitch of 30 mm and by compressing the wire elements in a circular shape, each of the wire elements being made of aluminum alloy and having a diameter of about 1.00 mm, and an insulator made of polyvinyl chloride was applied to this conductor to form an aluminum wire. Two aluminum wires were S-twisted with a twist pitch of 25 mm to form an aluminum twisted wire.

In a first comparative example, the conductor was formed by S-twisting eleven wire elements with a twist pitch of 30 mm and by compressing the wire elements in a circular shape, each of the wire elements being made of aluminum alloy and having a diameter of about 1.00 mm, and an insulator made of polyvinyl chloride was applied to this conductor to form an aluminum wire. Two aluminum wires were Z-twisted with a twist pitch of 25 mm to form an aluminum twisted wire.

In a second comparative example, the conductor was formed by S-twisting eleven wire elements with a twist pitch of 30 mm and by compressing the wire elements in a circular shape, each of the wire elements being made of pure copper and having a diameter of about 1.00 mm, and an insulator made of polyvinyl chloride was applied to this conductor to form an aluminum wire. Two aluminum wires were S-twisted with a twist pitch of 25 mm to form an aluminum twisted wire.

In a third comparative example, the conductor was formed by S-twisting eleven wire elements with a twist pitch of 30 mm and by compressing the wire elements in a circular shape, each of the wire elements being made of pure copper and having a diameter of about 1.00 mm, and an insulator made of polyvinyl chloride was applied to this conductor to form an aluminum wire. Two aluminum wires were Z-twisted with a twist pitch of 25 mm to form an aluminum twisted wire.

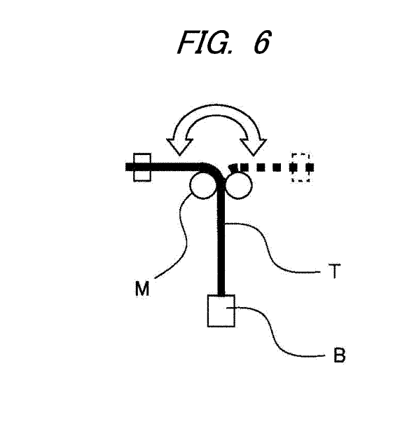

Then, a bending test was performed on the example of the present invention and the first to third comparative examples described above. FIG. 6 is a schematic diagram illustrating how the bending test is performed. Regarding the bending test, a weight B of 800 g was attached to one end of an aluminum twisted wire T, and with the one end being the fixed side, the other end side was repetitively bent in an angle range of −90° to 90° at a speed of 30 rpm by using a mandrel M having a diameter of 25 mm at normal temperature, and the number of times of bending (the number of times of reciprocation) at which the wire elements were broken (that is, when the average of the resistance values of the two electric wires is increased by 10% from that before bending) was measured.

First, the number of times of bending was 1402 in the third comparative example, and was 1513 in the second comparative example. For this reason, in the case of the twisted wires having wire elements made of pure copper, the difference in the number of times of bending was only less than 10 percent whether the twisting directions were opposite or the same.

On the other hand, while the number of times of bending was 163 in the first comparative example, in the exemplary embodiment, the number of times of bending was 650, and the number of times of bending increased nearly to approximately four times. For this reason, in the aluminum twisted wires, by making the twisting directions the same, flexibility significantly improves compared with when they are opposite directions.

As described above, the aluminum twisted wire 1 is configured such that the twisting direction of the wire elements 11a, 21a and the twisting direction of the aluminum wires 10, 20 are the same. With this configuration, force in a direction in which the wire elements 11a, 21a are untwisted, like the force in the case where the twisting directions are opposite, is hardly applied, so that the conductors 11, 21 are less likely to be deformed or flattened. Further, flex resistance is improved. Particularly, with the wire elements 11a, 21a made of aluminum or an aluminum alloy, flex resistance is significantly improved as compared with the wire elements made of copper or a copper alloy.

Moreover, the twist pitch of the wire elements 11a, 12a is in a range of one third of the twist pitch of the aluminum wires 10, 20 to three times the twist pitch of the aluminum wires 10, 20. This configuration can prevent the wire elements 11a, 12a or the aluminum wires 10, 20 from being untwisted. That is, when there is a large difference in the tightness of twist between the wire elements 11a, 21a and the aluminum wires 10, 20, e.g., when one of the twist pitches is long and the other is short, the ones that are twisted more tightly become easy to be untwisted.

Moreover, the wire harness WH according to the exemplary embodiment includes the aluminum twisted wire 1. Therefore, it is excellent in flex resistance and is suitable as the wire harness WH used at a location where it is bent repetitively.

While the present invention has been described with reference to certain exemplary embodiments thereof, the scope of the present invention is not limited to the exemplary embodiments described above, and it will be understood by those skilled in the art that various changes and modifications may be made therein without departing from the scope of the present invention as defined by the appended claims.

For example, in the aluminum twisted wire 1 according to the exemplary embodiment described above, each of the aluminum wires 10, 20 are formed by twisting eleven wire elements 11a, 21 a, but the number of wire elements 11a, 21 a is not specifically limited to eleven. Moreover, while the conductors 11, 21 are compressed at the end faces shown in FIGS. 3 and 4 after a plurality of wire elements 11a, 21a are twisted, they may not be compressed.

Moreover, while the aluminum twisted wire 1 according to the exemplary embodiment described above is intended to improve flex resistance, the aluminum twisted wire 1 may not always be used in a bent manner, and may also be used in a linearly extended manner.

1. An aluminum twisted wire comprising a plurality of aluminum wires that are twisted together, each of the aluminum wires comprising:
a conductor comprising a plurality of wire elements that are twisted together, the wire elements being made of aluminum or aluminum alloy; and
an insulator covering the conductor,
wherein a twisting direction of the wire elements and a twisting direction of the aluminum wires are the same.

2. The aluminum twisted wire according to claim 1, wherein a twist pitch of the wire elements is in a range of one third of a twist pitch of the aluminum wires to three times the twist pitch of the aluminum wires.

3. A wire harness comprising an aluminum twisted wire, the aluminum twisted wire comprising a plurality of aluminum wires that are twisted together, each of the aluminum wires comprising:
a conductor comprising a plurality of wire elements that are twisted together, the wire elements being made of aluminum or aluminum alloy; and
an insulator covering the conductor,
wherein a twisting direction of the wire elements and a twisting direction of the aluminum wires are the same.
